(19) United States
(12) Patent Application Publication
(10) Pub. No.: US 2023/0209011 A1
(43) Pub. Date: Jun. 29, 2023

(54) VEHICLE TRIP REVIEW SYSTEM

(71) Applicant: GENTEX CORPORATION, Zeeland, MI (US)

(72) Inventor: Daniel P. Bayer, Allendale, MI (US)

(73) Assignee: GENTEX CORPORATION, Zeeland, MI (US)

(21) Appl. No.: 18/059,628

(22) Filed: Nov. 29, 2022

Related U.S. Application Data
(60) Provisional application No. 63/294,446, filed on Dec. 29, 2021.

(51) Int. Cl. H04N 5/77; G01C 21/36; B60R 1/22

(52) U.S. Cl. CPC H04N 5/77; G01C 21/3647; B60R 1/22

(57) ABSTRACT

A vehicle system is disclosed. The system may comprise an imager, a location sensor, a controller, and a display. The imager may be operable to capture a first video having a plurality of frames with field of view exterior the vehicle. The location sensor may be operable to determine the vehicle's location. The controller may be operable to associate the location of the vehicle with a plurality of the plurality of frames where the location substantially corresponds to the vehicle's location when each respective frame was captured. Additionally, the controller may be further operable to store one or more video clips, each comprising a series of frames. The display may be operable to simultaneously show one of the video clips and a map of an area substantially encompassing all the locations of the vehicle associated with the first frames included in the shown video clip.

### CROSS-REFERENCE TO RELATED APPLICATIONS

This application claims priority under 35 U.S.C. § 119(e) to U.S. Provisional Application No. 63/294, 446 filed on Dec. 29, 2021, entitled “Vehicle Trip Review System,” the disclosure of which is hereby incorporated by reference in its entirety.

### FIELD OF INVENTION

The present disclosure relates, in general, to vehicle DVR systems and, more particularly, to vehicle DVR systems with location tracking.

### SUMMARY

In accordance with one aspect of the present disclosure, a system for a vehicle is disclosed. The system may comprise a first imager, a location sensor, a controller, and a display. The first imager may be operable to capture a first video having a plurality of first frames. Further, the first imager may have a first field of view exterior the vehicle. The location sensor may be operable to determine a location of the vehicle. The controller may be communicatively connected to the first imager and the location sensor. Further, the controller may be operable to associate the location of the vehicle with a plurality of the plurality of first frames where the location substantially corresponds to the vehicle's location when each respective first frame was captured. Additionally, the controller may be further operable to store one or more first video clips, each comprising a series of the first frames. The display may be communicatively connected to the controller. In some embodiments, the display may be part of a mobile communications device. Further, the display may be operable to simultaneously show one of the first video clips and a map of an area substantially encompassing all the locations of the vehicle associated with the first frames included in the shown first video clip. In some embodiments, substantially all the locations are represented as a line of travel on the map representing the vehicle's journey for the duration of the shown first video clip. In some such embodiments, during display of the shown video clip, the vehicle's location most recently stored relative a currently displayed first frame may be shown as a marker along the mapped line of travel. In some embodiments, storage of a first video clip may be triggered based, at least in part, on receipt by the controller of a signal indicative of a vehicle event or a user input. In some such embodiments, the stored first video clip is composed of first frames from a predetermined amount of time prior to the trigger and a predetermined amount of time after the trigger. In some embodiments, the controller may store the received first frames in one or more video segments of a predetermined duration. Additionally, the one or more first video clips may be formed by stitching together appropriate video segments.

In some embodiments, one or more of the first video clips may correspond to a substantially complete trip of the vehicle. In some such embodiments, the trip of the vehicle may be determined based, at least in part, on a first parked location of the vehicle and a second parked location of the vehicle. In other such embodiments, the trip of the vehicle may be determined based, at least in part, on an entering of a destination into a navigation platform and reaching the destination. In yet other such embodiments, the controller may be further operable to store an additional first video clip based, at least in part, on receipt, by the controller of a signal indicative of a vehicle event or a user input during the trip. The additional first video clip may be smaller than the first video clip corresponding to the substantially complete trip of the vehicle.

In some embodiments, the system may further comprise a second imager. The second imager may be operable to capture a second video having a plurality of second frames. Additionally, the second imager may have a second field of view exterior the vehicle different than the first field of view. In such an embodiment, the controller may be communicatively connected to the second imager and further operable to store one or more second video clips from the second imager. Additionally, the display may be further operable to shown one of the second video clips substantially time synchronized and simultaneous with the shown first video clip. In some such embodiments one of the first and second fields of view may be forward relative the vehicle and other of the first and second fields of view may be rearward relative the vehicle. In other such embodiments, the signal may be indicative of a user input received via a user interface of a rearview assembly associated with the vehicle. In other such embodiments, the signal indicative of a vehicle event may correspond to a signal from a shock sensor associated with the vehicle. In Accordingly, the vehicle event may be a collision.

These and other aspects, objects, and features of the present disclosure will be understood and appreciated by those skilled in the art upon studying the following specification, claims, and appended drawings. Further, features of each embodiment disclosed herein may be used in conjunction with, or as a replacement for, features in other embodiments.

### BRIEF DESCRIPTION OF FIGURES

In the drawings:

FIG. 1: a schematic representation of a system;

FIG. 2a: a representation of a display showing a first video clip and a map;

FIG. 2b: a representation of a display showing a second video clip and a map; and

FIG. 2c: a representation of a display showing both a first and a second video clip and a map.

### DETAILED DESCRIPTION

For the purposes of description herein, the specific devices and processes illustrated in the attached drawings and described in this disclosure are simply exemplary embodiments of the inventive concepts defined in the appended claims. Hence, specific characteristics relating the embodiments disclosed herein are not limiting, unless the claims expressly state otherwise.

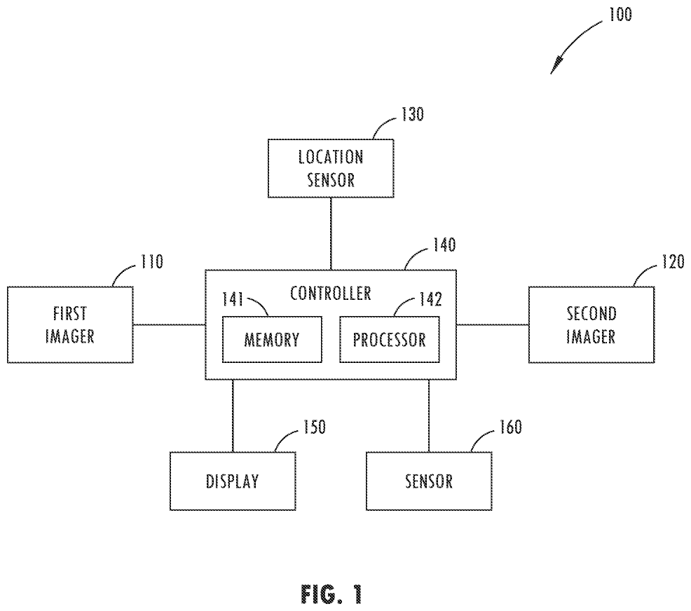

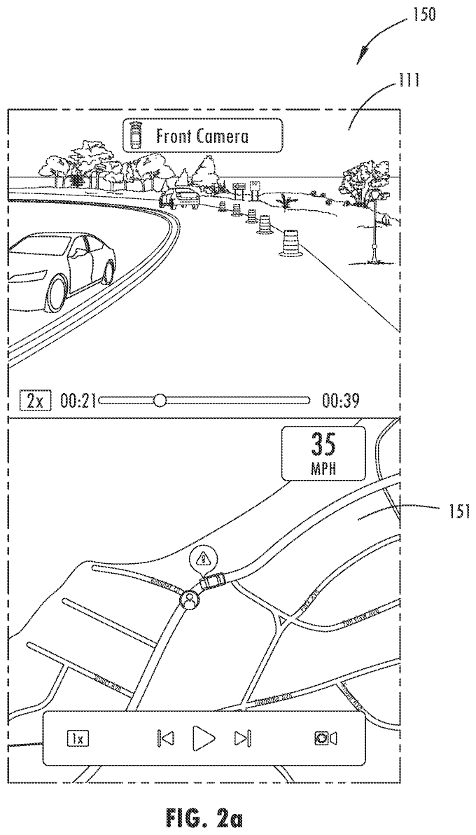

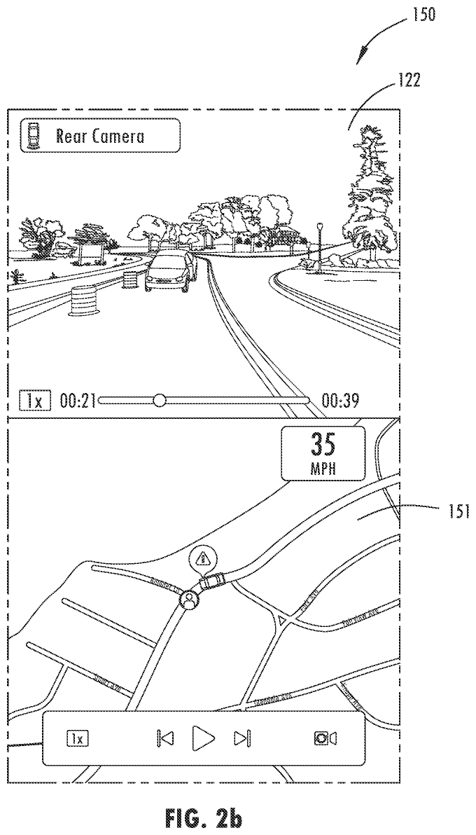

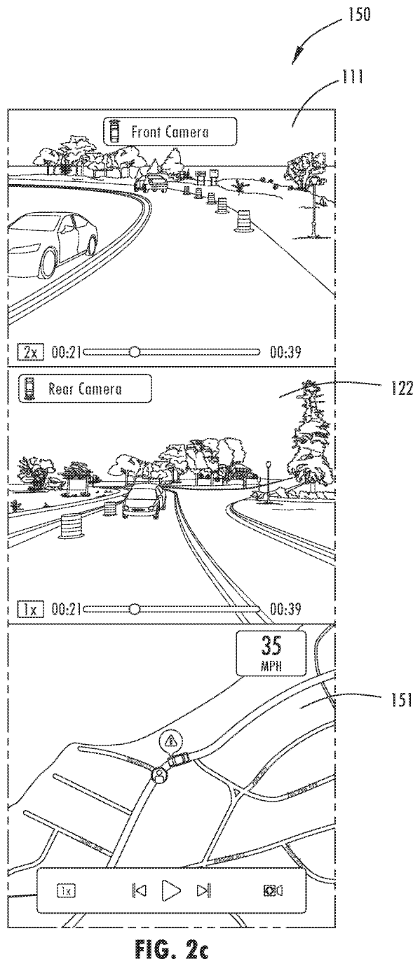

FIGS. 1-2c illustrate aspects of embodiments of a system 100. System 100 may comprise a first imager 110, a second imager 120, a location sensor 130, a controller 140, and/or a display 150. Further, system 100 may be associated with a vehicle. The vehicle, for example, may be an automobile, such as a car, truck, van, or bus. Additionally, system 100 may be operable to allow a user to review all or part of trips made by the vehicle. For example, system 100 may allow the user to review video clips along with an associated map.

First imager 110 may be operable to capture light and generate a plurality of corresponding images. Additionally, first imager 110 may be a Semi-Conductor Charge-Coupled Device (CCD) or a pixel sensor of Complementary Metal-Oxide-Semi-Conductor (CMOS) technologies. For example, first imager 110 may be a camera. The images may be captured in series as a first video. The first video may thus comprise a plurality of first frames. Further, first imager 110 may have a first field of view. The first field of view may be exterior relative the vehicle. For example, the first field of view may be forward and/or rearward relative the vehicle. Accordingly, the first field of view may substantially correspond to a driver's forward field of view through the vehicle's windshield or to a field of view traditionally associated with an interior rearview assembly, driver-side exterior rearview assembly, passenger-side exterior rearview assembly, or back-up camera. Thus, first imager 110 may be associated with the vehicle.

Second imager 120 may be operable to capture light and generate a plurality of corresponding images. Additionally, second imager 120 may be a Semi-Conductor Charge-Coupled Device (CCD) or a pixel sensor of Complementary Metal-Oxide-Semi-Conductor (CMOS) technologies. For example, second imager 120 may be a camera. The images may be captured in series as a second video. The second video may thus comprise a plurality of second frames. Further, second imager 120 may have a second field of view. The second field of view may be exterior relative the vehicle. For example, the second field of view may be forward and/or rearward relative the vehicle. Accordingly, the second field of view may substantially correspond to a driver's forward field of view through the vehicle's windshield or to a field of view traditionally associated with an interior rearview assembly, driver-side exterior rearview assembly, passenger-side exterior rearview assembly, or back-up camera. Thus, second imager 110 may be associated with the vehicle. In some embodiments, the second field of view may be different than the first field of view.

Location sensor 130 may be any device operable to determine a position of the vehicle. Thus, location sensor 130 may be associated with the vehicle. Location sensor 130, for example, may be a global positioning system (GPS) unit or cellular triangulation unit. In some embodiments, location sensor 130 may be embedded in a user's mobile communications device, such as a cell phone.

Controller 140 may comprise a memory 141 and/or a processor 142. Memory 141 may be configured to store one or more algorithms operable to carry out the functions of controller 140. Processor 142 may be operable to execute the one or more algorithms. Additionally, controller 140 may be communicatively connected to: first imager 110, second imager 120, and/or location sensor 130. As used herein, “communicatively connected” may mean connected directly or indirectly though one or more electrical components. Accordingly, controller 140 may be operable to receive the vehicle's location from location sensor 130. Further, controller 140 may be operable to associate the location of the vehicle with a plurality of the plurality of first frames. The associated location may substantially correspond to the vehicle's location when each respective first frame was captured. Furthermore, controller 140 may be operable to store one or more first and/or second video clips 111, 122. Each first video clip 111 may comprise a series of the first frames. Similarly, second video clip 122 may comprise a series of second frame. Additionally, each first and/or second video clip 111, 122 may further comprise a plurality of the first or second frames, associated with a location, respectively. In some embodiments, the first and/or second frames may be compiled and/or stored according to a time interval. The time intervals may start when the vehicle is turned on and may end when the vehicle is turned off. For example, the time interval may be one minute. In such an instance, after each minute elapses, controller 140 may compile and/or store a group of first and/or second frames recorded during the most recently elapsed minute. Accordingly, the first and/or second video clips 111, 122 may comprise one or more of the groups of the first and/or second frames, respectively. These groups may be strung together to provide a single, substantially continuous video clip. Further, the last group of first and/or second frames may be less than a minute as it may comprise first and/or second frames from the lapsation of the preceding minute until the vehicle is turned off. In some embodiments, the first and/or second video clips 111, 122 may comprise one or more groups of the groups of the first and/or second frames, respectively, such that the first and/or second video clip 111, 122 substantially corresponds to a substantially complete vehicle trip. The trip of the vehicle may be determined based, at least in part, on a first parked location or time of the vehicle; a second parked location or time of the vehicle; an entering of a destination of into a navigation platform; and/or reaching a destination input into the navigation platform. Additionally or alternatively, in some embodiments, the storage of one or more first and/or second video clips 111, 122 and/or the selection of frames and/or groups of frames to create the first and/or second video clips 111, 122 may be based, at least in part, on a trigger. For example, the video clip may be composed of frames from at least a predetermined amount of time prior to the trigger and at least a predetermined amount of time after the trigger. In some such embodiments, the trigger may be based, at least in part, on receipt by controller 140 of a signal indicative of a vehicle event or a user input. In some embodiments, the signal may originate from a vehicle sensor 160. Sensor 160 may be a shock sensor. Accordingly, the vehicle event may correspond to a vehicle collision.

Display 150 may be operable to show one or more images. Further, display 150 may be communicatively connected to controller 140. In some embodiments, display 150 may be disposed in an interior rearview assembly of the vehicle. In other embodiments, display 150 may be a display of the user's mobile communications device. Additionally, display 150 may be operable to simultaneously show at least one of the first and/or second video clips 111, 122 and a map 151. In some embodiments, the at least one of the first and/or second video clips 111, 122 and map 151 may be shown adjacent one another. Further, each of a first video clip 111 and a second video clip 122 may be synchronously displayed. The map may be of an area substantially encompassing all of the locations of the vehicle associated with the first frames in the shown first and/or second video clips 111, 122. In some embodiments, substantially all of the locations of the shown video clip may be represented as a line of travel on the map 151. Thus, line may represent the vehicle's journey for the duration of the shown first and/or video clips 111, 122. In some such embodiments, during the display of the shown video clip, the vehicle's location most recently stored relative a currently displayed frame may be shown as a marker along the mapped line of travel.

In this document, relational terms, such as “first,” “second,” and the like, are used solely to distinguish one entity or action from another entity or action, without necessarily requiring or implying any actual such relationship or order between such entities or actions.

As used herein, the term “and/or,” when used in a list of two or more items, means that any one of the listed items can be employed by itself, or any combination of the two or more of the listed items can be employed. For example, if a composition is described as containing components A, B, and/or C, the composition can contain A alone; B alone; C alone; A and B in combination; A and C in combination; B and C in combination; or A, B, and C in combination.

The term “substantially,” and variations thereof, will be understood by persons of ordinary skill in the art as describing a feature that is equal or approximately equal to a value or description. For example, a “substantially planar” surface is intended to denote a surface that is planar or approximately planar. Moreover, “substantially” is intended to denote that two values are equal or approximately equal. If there are uses of the term which are not clear to persons of ordinary skill in the art, given the context in which it is used, “substantially” may denote values within about 10% of each other, such as within about 5% of each other, or within about 2% of each other.

For purposes of this disclosure, the term “associated” generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

What is claimed is:

1. A system for a vehicle comprising:
a first imager operable to capture a first video having a plurality of first frames, the first imager having a first field of view exterior the vehicle;
a location sensor operable to determine a location of the vehicle;
a controller communicatively connected to the first imager and the location sensor, the controller operable to:
associate the location of the vehicle with a plurality of the plurality of first frames where the location substantially corresponds to the vehicle's location when each respective first frame was captured, and
store one or more first video clips, each comprising a series of the first frames; and
a display communicatively connected to the controller, the display operable to simultaneously show one of the first video clips and a map of an area substantially encompassing all the locations of the vehicle associated with the first frames included in the shown first video clip.

2. The system of claim 1, wherein substantially all the locations are represented as a line of travel on the map representing the vehicle's journey for the duration of the shown first video clip.

3. The system of claim 2, wherein during display of the shown video clip, the vehicle's location most recently stored relative a currently displayed first frame is shown as a marker along the mapped line of travel.

4. The system of claim 1, wherein storage of a first video clip is triggered based, at least in part, on receipt by the controller of a signal indicative of a vehicle event or a user input.

5. The system of claim 4, wherein the stored first video clip is composed of first frames from a predetermined amount of time prior to the trigger and a predetermined amount of time after the trigger.

6. The system of claim 1, wherein:
the controller stores the received first frames in one or more video segments of a predetermined duration; and
the one or more first video clips are formed by stitching together appropriate video segments.

7. The system of claim 1, wherein one or more of the first video clips correspond to a substantially complete trip of the vehicle.

8. The system of claim 7, wherein the trip of the vehicle is determined based, at least in part, on a first parked location of the vehicle and a second parked location of the vehicle.

9. The system of claim 7, wherein the trip of the vehicle is determined based, at least in part, on an entering of a destination into a navigation platform and reaching the destination.

10. The system of claim 7, wherein: the controller is further operable to store an additional first video clip based, at least in part, on receipt, by the controller of a signal indicative of a vehicle event or a user input during the trip, the additional first video clip smaller than the first video clip corresponding to the substantially complete trip of the vehicle.

11. The system of claim 1, further comprising:
a second imager operable to capture a second video having a plurality of second frames, the second imager having a second field of view exterior the vehicle different than the first field of view;
wherein:
the controller is communicatively connected to the second imager and is further operable to store one or more second video clips from the second imager, and
the display is further operable to shown one of the second video clips substantially time synchronized and simultaneous with the shown first video clip.

12. The system of claim 11, wherein one of the first and second fields of view is forward relative the vehicle and other of the first and second fields of view is rearward relative the vehicle.

13. The system of claim 10, wherein the signal is indicative of a user input received via a user interface of a rearview assembly associated with the vehicle.

14. The system of claim 1, wherein the display is part of a mobile communications device.

15. The system of claim 10, wherein the signal indicative of a vehicle event corresponds to a signal from a shock sensor associated with the vehicle.

16. The system of claim 10, wherein the vehicle event is a collision.
